(19) United States
(12) Patent Application Publication
(10) Pub. No.: US 2006/0056297 A1
(43) Pub. Date: Mar. 16, 2006

(54) Method and apparatus for controlling traffic between different entities on a network

(75) Inventors: Harry Andrew Bryson, Musselburgh (GB); Malcolm Graham Dodds, Edinburgh (GB)

Correspondence Address: JACKSON & CO., LLP, 6114 LA SALLE AVENUE, SUITE 507, OAKLAND, CA, 94611-2802, US

(73) Assignee: 3Com Corporation

(21) Appl. No.: 11/031,776

(22) Filed: Jan. 7, 2005

(30) Foreign Application Priority Data
Sep. 14, 2004 (GB) 04 204 28.5

(51) Int. Cl. H04L 12/26

(52) U.S. Cl. 370/230; 370/235; 370/352; 370/401

(57) ABSTRACT

A method for controlling traffic between different entities on a network in which packets of received data are inspected, and if encapsulated, are decapsulated layer by layer and, after each layer is decapsulated, the packet is inspected to determine if the packet is to be acted upon or discarded. Apparatus for controlling traffic between different entities on a network in accordance with a predetermined policy, the policy being applied to network traffic being passed between logical zones, wherein each logical zone can be simultaneously associated with one or more types of network entity and in particular t at least one of said source and destination zones includes both physical entities and logical entities,

### BACKGROUND TO THE INVENTION

The present invention relates to a method and apparatus for controlling traffic between different entities on a network.

We define “network entity” in this matter as including various types of entity such as;

physical entities comprising IP addresses, ports, devices, remote or local networks or sub networks VLANs, and

logical entities such as tunnels (of various protocols such as IPSec (Internet Protocol Security (IETF)) and GRE (Generic Router Encapsulation) tunnels), internet, items relating to the time of receipt of the packet, or the application (e.g. TCP/UDP IP services such as HTTP, SMTP), or number of bytes in the packet or the rate of receipt of traffic etc.

A router which applies network traffic policy (such as a firewall router) applies a defined network traffic policy between different physical addresses, e.g. different IP addresses of devices on a network. Effectively, it will only allow access between addresses in accordance with a policy The addresses are usually gathered together in a so-called zone. Thus, for example, all computers which are used by a sales team may be in a “sales zone” and all computer which are used by an accounts department are in a “accounts zone” and these two zones will have access to different IP addresses, i.e. to different computers or servers which hold, for example, information relevant to their job.

The different network entities between which network policy could be enforced needed to be configured as part of the policy.

Hitherto, policy configuration is complex and a policy needs to be modified to support new types of network entities. Thus each time there is a change of entity in the network, it is necessary to modify the policy.

Security devices can enforce policy on the traffic between different network points. Basic devices enforce this policy purely on the source or destination network addressing information contained within packets. More complex devices can enforce the policy based on the source or destination location where a location can be defined in terms of physical port, VLAN, tunnel endpoint, etc. In such devices, policy configuration is complex.

There are also problems in dealing with packets of data from VLANs or tunnel which are encapsulated. Present systems only inspect the encapsulated packet.

### SUMMARY OF THE INVENTION

The present invention provides, according to another aspect, a method and apparatus for controlling traffic between different entities on a network in accordance with a predetermined policy in which the network policy is applied to each layer within a layered tunnel model.

The present invention provides, according to a one aspect, a method and apparatus for controlling traffic between different entities on a network in which packets of received data are inspected, and if encapsulated, are decapsulated layer by layer and, after each layer is decapsulated, the packet is checked to determine if the packet is to be forwarded or otherwise acted upon or discarded.

Thus the packet of data is thoroughly inspected before forwarding which improves security.

Preferably the apparatus of the invention further provides:

(a) means to receive packets of data,

(b) means to inspect each packet and discard the packet if it is determined that it should not be forwarded or otherwise acted upon,

(c) means to determine if the packet is encapsulated,

(d) means to decapsulate the inspected packet if it is encapsulated,

(e) means to repeat steps (b), (c) and (d) on the decapsulated packet, and

(f) means to forward or otherwise act upon the packet if it is not encapsulated.

Preferably the method of the invention further provides:

(a) receiving packets of data,

(b) inspecting each packet and discarding the packet if it is determined that it should not be forwarded or otherwise acted upon,

(c) determining if the packet is encapsulated,

(d) decapsulating the inspected packet if it is encapsulated,

(e) repeating steps (b), (c) and (d) on the decapsulated packet, and

(f) forwarding or otherwise acting upon the packet if it is not encapsulated.

Generally, prior arrangements only inspect the packet when it has been completely decapsulated by examining the data. It will be understood that by the use of an iteration (by repeating steps (b), (c) and (d)) of this aspect of the invention, by the decapsulation of the packet and inspecting the packet at each decapsulation, greater security can be provided to avoid forwarding packets containing unwanted data.

Preferably the packet can be encapsulated before forwarding.

The step (b) may include inspecting the packet to see if it matches a previous session (i.e. have packets of that type already been inspected and found not to be of a type to be discarded) and if so passing to step (c), and if not,

(b1) calculating a forwarding path for the packet

(b2) associating the packet with a logical forwarding zone,

(b3) determining if the policy allows the packet to be forwarded or otherwise acted upon,

(b4) if the policy does not allow the packet to be forwarded or otherwise acted upon, discarding the packet,

(b5) if the policy does allow the packet to be forwarded or otherwise acted upon, creating a new session entry and proceeding to step (c).

According to another aspect, the invention provides a computer program on a computer readable medium for controlling traffic between different entities on a network in which packets of received data are inspected, and if encapsulated, are decapsulated layer by layer and, after each layer is decapsulated, the packet is inspected to determine if the packet is to be acted upon or discarded, said program comprising

program means for receiving packets of data,

(b) program means for inspecting each packet and discarding the packet if it is determined that it should not be acted upon,

(c) program means for determining if the packet is encapsulated,

(d) program means for decapsulating the inspected packet if it is encapsulated,

(e) program means to repeat steps (b), (c) and (d) on the decapsulated packet, and

(f) program means to act upon the packet.

According to another aspect of the present invention, there is provided a method and apparatus for controlling traffic between different entities on a network in accordance with a predetermined policy, the policy being applied to network traffic being passed between logical security zones, wherein each logical security zone can be simultaneously associated with one or more types of network entity.

An advantage of this arrangement is that it allows great flexibility in adding to the logical security zone without changing the policies. For example, if there is a zone which we can refer to as the “sales department” zone, it is possible to add a remote sales departments via a VLAN or tunnel simply by adding the VLAN or tunnel attributes to the “sales department” zone without amending the policy and so the remote sales force will then have the same access to the network as the local sales force.

Also the use of, for example time in defining the zone has uses not provided by the prior arrangements. For example, one might define an “office zone” which is defined, inter alia, by a time of 8am to 6pm. This would mean that the routing of packets would be barred at any time outside those hours which would be an added security feature. This does not need a change of or definition in policy.

According to a preferred arrangement of this aspect of the invention there is provided a method and apparatus in which there is provided

(a) defining a plurality of zones,

(b) defining a plurality of actions or policies,

(c) receiving packets of data,

(d) inspecting the packet and device configuration to determine its source zone and its destination zone

(e) applying the policy relating to the relevant source and destination zones to determine from that policy whether the packet should be acted upon or discarded, characterised in that at least one of said source and destination zones includes both physical entities and logical entities,

Thus, different types of network entities (i.e. physical and logical entities) can be introduced to a zone without a change of policy.

Preferably, said at least one of said source and destination zones includes items relating to the time of receipt of the packet, or the application (e.g. TCP/UDP IP services such as HTTP, SMTP), or number of bytes in the packet.

Thus, the source and destination zone may comprise logical security zones which can be associated with any group of network locations, including physical ports, VLANs, or logical tunnel termination points for IPSec, GRE, PPTP (Point to Point Tunnelling Protocol) or L2TP (Layer 2 Tunnelling Protocol)

Preferably the network policy is classified in terms of source and destination logical security zone.

Thus a logical security zone's network locations may also be updated without modifying actual policy configuration, simplifying the task of migrating to a new network configuration. Future network locations can be added to a logical security zone without changing the policy configuration.

Any traffic between network locations that are within the same logical security zone is not subject to policy further simplifying policy configuration for trusted network locations.

### DRAWINGS

Preferred embodiments of the invention will now be described by way of example and with reference to the accompanying drawings in which:

FIG. 1 is a diagrammatic view of a network for use with the invention,

FIG. 2 is diagram illustrating the relationship between source logical security zones, destination logical zones, and policy rules,

FIG. 3 is a flow diagram of the operation of the apparatus of the invention

FIG. 4 is a layout of a firewall in accordance with the invention, and

FIG. 5 is a diagram of the connection between two peer devices.

### DESCRIPTION OF THE PREFERRED EMBODIMENTS

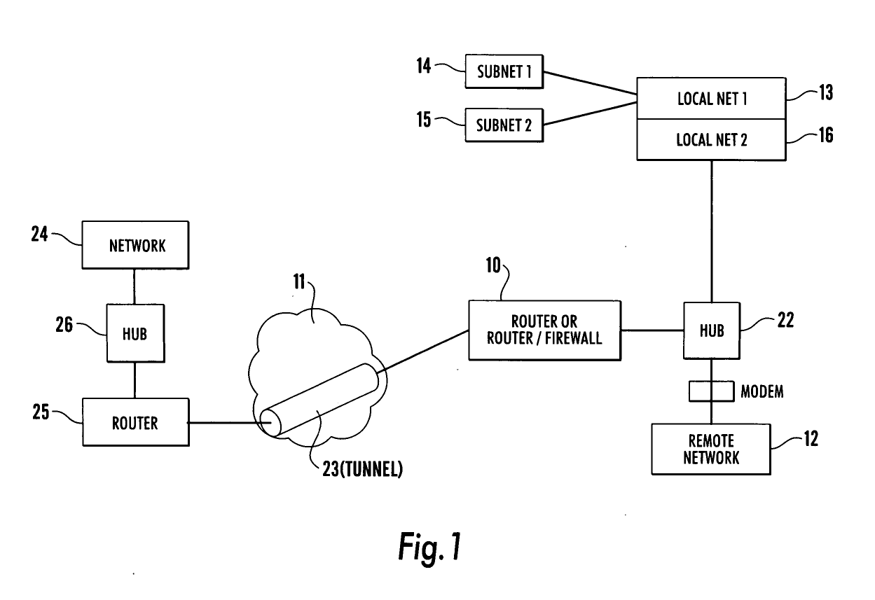

We will now describe a preferred embodiment of the invention with reference to FIG. 1.

As is shown in FIG. 1, a network router 10 controls traffic between various entities, for example for access to internet 11, to a hub 22 which is connected to a first network 12, (which for example may be connected by a dial up modem), a second network 13 (LOCALNET 1) which includes two subnetworks 14, 15, and another network 16 (LOCALNET 2). The whole arrangement shown in FIG. 1 comprises a main network.

The router 10 is connected via a tunnel 23 in internet 11 to a remote network 24 via a router 25, a hub 26.

Each network of course will comprise a plurality of devices such as work-stations, personal computers, and connections for laptop computers, printers, and the like.

The router 10, if it is a router/firewall, includes means to control traffic between the different entities on the network.

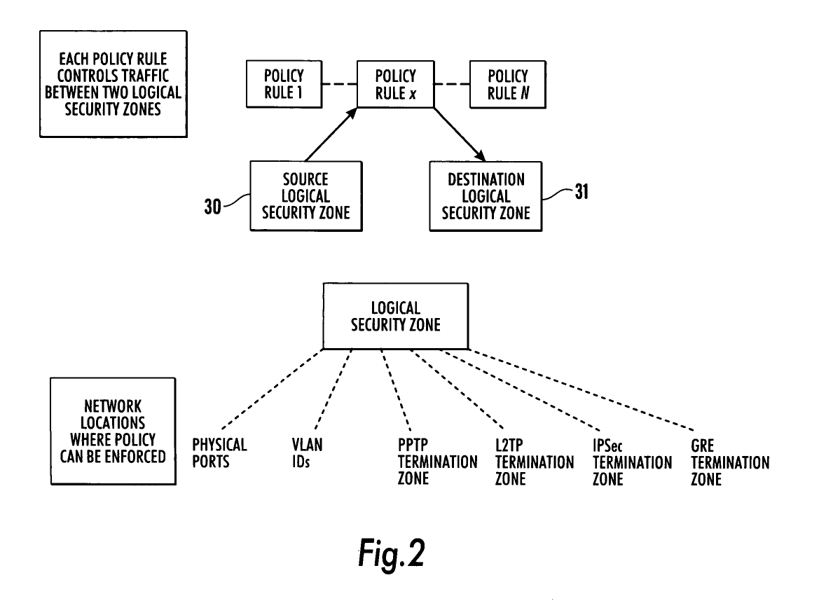

In essence, the various entities (which may not necessarily be physical devices, as will become clear later) are divided into logical security zones. One logical security zone is illustrated at 30 in FIG. 2 and there is also defined a destination logical security zone 31. There may be many logical security zones which may act as source or destination. For ease of handling, each logical security zone may be given a name, such as Alan, Beryl, Finance Department, Sales Department. The router 10 includes a network traffic controller which may be in the form of software or hardware which controls access between the different logical security zones. The traffic may be controlled by means of a range of policies. Thus connecting source logical security zone A to destination logical security zone B may be associated with a policy A. For connecting a source logical security zone C to a destination logical security zone D may be controlled by a policy rule B.

As is also clear from FIG. 2, the logical security zones may relate to physical entities such as ports, VLAN IDs and/or logical entities such as, PPTP termination zones, L2 TP termination zone, IPSec termination zone, or GRE termination zone for example. It will be clearly understood that the logical security zones do not necessarily simply include a number of physical entities or devices but, as is clear may include other logical entities.

Thus the router will examine any data packet from a source logical security zone and determine in accordance with the relevant policy rule whether that source packet can be passed to a destination logical security zone.

The network router includes an apparatus for controlling traffic (i.e. the data packets) between different entities on a network which will hereafter be referred to as a network traffic controller. The network traffic controller may be provided in the form of software operating on a router or the like or may be in the form of a dedicated device. The network traffic controller enforces traffic control between networks segments contain policy enforcement points which are typically associated with the physical network interfaces or VLANs of the product.

The network traffic controller uses the concept of a virtual security zone from which a data packet is received on to which it is to be sent. This is a logical policy enforcement point that not only can be associated with physical entities such as physical network interfaces or VLANs, but can also be associated with logical entities such as tunnel termination points, such as the end of a GRE, IPSec, PPTP or L2TP tunnel and a security zone can be associated with a list of ranges of IP addresses. Any traffic received which is not within this network protection range results in a security event indicating spoofed network traffic.

A logical entity of a security zone can be associated with inbound and outbound traffic rates. This can be used to limit the rate of traffic over a VPN tunnel to minimise network queuing and hence reduce network latency for latency sensitive traffic.

Intrusion detection can be enabled or disabled on a security zone. Any sort of network attack can be detected on not only physical ports but any supported VPN tunnel. For trusted security zones, intrusion detection can be disabled to improve performance.

For convenience, each security zone is associated with a name (Alan, Beryl, Finance Department, Sales Department). A policy rule can use the security zone's name as the source or destination of packets for policy enforcement between security zones.

If physical ports, VLANs or logical tunnel termination points are associated with the same security zone, there is no network traffic restriction between these entities.

As examples, any combination of the following can be used to classify a packet into a logical security zone for use within policy as a source or destination zone:

A. Physical entities:
1. The physical port that packet was received or transmitted on
   a. Each security zone can be associated with any set of ports.
2. The VLAN tag associated with received or transmitted packet
   a. A VLAN ID can be directly associated with each security zone. The ports that are allowed to receive tags packets with this VLAN ID are associated with each (source) security zone.
   b. For transmission to a (destination) security zone, a VLAN tag associated with the next hop of the IP subnet that the packet is being routed to.
   c. For reception, the VLAN tag is contained within the packet itself. (A packet does not necessarily contain a VLAN tag. In this case, the packet is associated with a port, not a VLAN.)
3. The set of IP source or destination addresses associated with a packet.
   a. Each security zone is associated with a set of IP address ranges associated with the zone.
   b. For transmission, the destination IP address of the packet is matched to the zone's IP address set

For reception, the source IP address of the packet is matched to the zone's IP address set
4. The set of network users that belong to a zone.
   a. Each user is associated with a unique network address.
   b. Each network address is associated with a particular zone (8)
   c. The device can map each network address to a user by:
      i. Manual configuration of the user to network address mapping

Automatic retrieval through a name resolution protocol, such as DNS, of the user to network address mapping

B. Logical entities:
5. The particular IPSec tunnel the packet is associated with for encapsulation or decapsulation
   a. IPSec configuration includes the IPSec termination security zone.
   b. For transmission over the tunnel, this is related to matching destination IP address of the packet with the destination subnets associated with the IPSec tunnel
   c. For reception from the tunnel, this is related to matching the peer IP address that the packet was received from to the IPSec tunnel associated with this peer.
6. The particular PPTP tunnel the packet is associated with for encapsulation or decapsulation
   a. Each user that terminates on the device using a PPTP VPN tunnel is configured with a VPN security zone.
   b. For transmission over the tunnel, this is related to matching the destination IP address of the packet with the remote PPTP client that was assigned this IP address during PPTP termination.
   c. For reception from the tunnel, this is related to matching the client IP address that the packet was received from to the PPTP configuration associated with this client.
7. The particular L2TP tunnel the packet is associated with for encapsulation or decapsulation
   a. Each user that terminates on the device using a L2TP VPN tunnel is configured with a VPN security zone.
   b. For transmission over the tunnel, this is related to matching the destination IP address of the packet with the remote L2TP client that was assigned this IP address during PPTP termination.
   c. For reception from the tunnel, this is related to matching the client IP address that the packet was received from to the L2TP configuration associated with this client.
8. The particular GRE tunnel the packet is associated with for encapsulation or decapsulation
   a. Each GRE tunnel includes the GRE security zone.
   b. For transmission over the tunnel, this is related to matching the destination IP address of the packet with the next hop entry within the IP routing table where the next hop entry is the IP address associated with the GRE tunnel
   c. For reception from the tunnel, this is related to matching the peer IP address that the packet was received from to the GRE tunnel associated with this peer.
9. The time that packet was received/transmitted
   Each security zone can be associated with a set of time ranges
10. The number of bytes within packet.
   a. Each security zone is associated with a range of packet sizes that are accepted for that zone.
11. The application
   a. Each security zone is associated with a set of applications (i.e. HTTP (web browsing) SMTP (e-mail) DNS etc). A packet is classified into the zone if it is using one of these applications.
      i.
12. The 802.1P tag
   a. Each zone is associated with VLAN priority contained within packet.
13. The DSCP (Diffserv Codepoint)
   a. Each zone is associated with a set of Diffserv code points that associate the packet with a particular zone
14. The fragmentation support
   a. A logical security zone can be configured to include or exclude IP fragmented packets.
      Logical Zone Configuration

The following describes how logical zoning is configured:

Each logical zone has a user-defined name assigned to it (Alan Beryl, Finance Department, Sales Department). This name is associated with a zone configuration record that contains the following manually configured data:
Priority. The zone list is ordered. Packet matching against zones is performed against the highest priority zone and, if matching fails, proceeds to match against lower priority zones.
Untagged port list. (A list of physical port numbers.)
Tagged port list. (A list of physical port numbers.)
VLAN ID
Schedule. (A list of time ranges.)
Network protection IP address list. (List of IP address ranges and IP subnets.)
Packet size list. (A list of ranges of packet sizes.)
Application list.
802.1P tag list
DSCP tag list
Fragmentation allowed option.

Other configuration elements within the device, such as IPSec tunnel, PPTP server, L2TP server, GRE interface or users have a configuration element called “security zone” that allows them to be associated with a ordered list of security zones.

The packet has to match one of the primary matching requirements and then all of the secondary matching requirements associated with the zone configuration record. A packet that does not match any zone is discarded.

Primary matching requirements:
A packet without a VLAN tag is sent to or received over an “untagged” port associated with the zone.
A packet with a VLAN tag corresponding to the zone's VLAN tag is sent to or received on a “tagged” port associated with the zone.
A packet is sent to or received from a PPTP, L2TP, IPSec or GRE tunnel associated with a particular zone.

Any zone can be configured to match all packets with the primary requirements.

Secondary matching requirements:
Schedule. Default: Always. If the packet is sent or received outside the zone's schedule, it is not associated with this zone.
Network protection IP address list. Default: Network protection off. If the packet is received by the device with a source IP address outside the network protection list, it is not associated with this zone. If a packet is sent by the device to a destination IP address outside the network protection list, it is not associated with this zone.
Packet size list. Default: all packet sizes. If the packet size is not within the packet size list, it is not associated with the zone.
Application list. Default: all applications. If the packet does not correspond to an application within the application list, it is not associated with the zone.
User list. Default: all users. If the packet is not associated with an IP address associated with an authorised user, it is not associated with the zone.
802.1P tag list. Default: all 802.1P tags. If the packet does not contain an appropriate 802.1P tag, it is not associated with the zone.
DSCP tag list. Default: all DSCP tags. If the packet does not contain an appropriate DSCP tag, it is not associated with the zone.

Fragmented support. Default: allow fragments. If fragmented support is disabled, packets that are IP fragments are not associated with the zone.

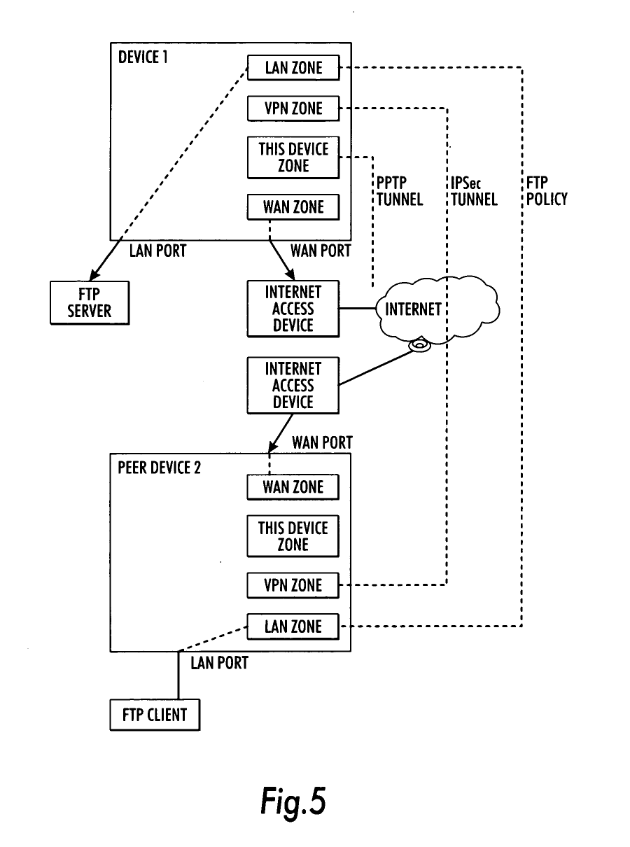

Referring to FIG. 5, we will now describe an example of FTP policy within IPSec tunnel within PPTP tunnel. Each tunnel layer is policed by firewall module.

Required Configuration for device 1 of FIG. 5:

Policy Rules

| | Source | Destination | | |
|---|---|---|---|---|
| Action | Zone | Zone | Application | Comments |
| Allow | This | WAN zone | PPTP | Allow PPTP connection |
| | Device | | | to Internet |
| Allow | WAN | This Device | IPSec | Allow incoming IPSec |
| | zone | | | tunnel over PPTP tunnel. |
| Allow | VPN | LAN zone | FTP | Allow FTP application |
| | zone | | | over IPSec tunnel |
| Deny | ANY | ANY | All services | Block all other traffic |
| | | | | between logical security |
| | | | | zones |

The IPSec tunnel is configured to terminate in VPN logical security zone. The LAN security zone is associated with physical Ethernet port connected to LAN.

The WAN security zone is associated with physical Ethernet port connected to Internet access device.

“This Device” will be defined as a logical security zone associated with packet originating or destined to the firewall device itself.

The process steps:

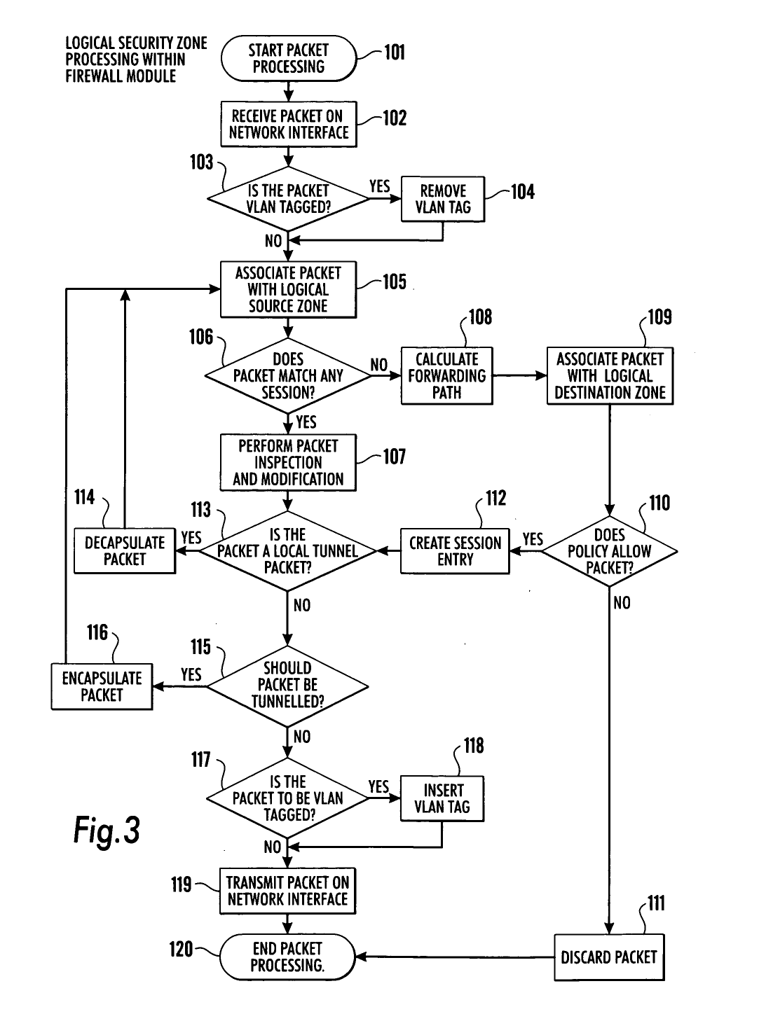

We will now refer to FIG. 3 which is a flow diagram of the method of the invention.

The software or hardware apparatus which comprises the network traffic controller (firewall module) operates on the received packets of data as follows:

Step 101 Start packet processing

Step 102 Receive Packet on Network Interface
A packet can be received by the firewall module from either of the following sources:
   An Ethernet packet is transmitted externally over an Ethernet network and enters the device through one of the physical Ethernet ports attached to the device.
   The device itself can originate packets from the local network stack and these are directly sent to the firewall module. All network traffic originating from the device is policed by the firewall module
A classification record is associated with the packet as it traverses the firewall module.

Step 103 Is the packet VLAN tagged? If yes, go to step 104, if no, go to step 105.

Step 104, remove VLAN tag and go to step 105

Step 105 Associate Packet with Logical Source Zone and go to step 106.
For packets received by a physical Ethernet port, these can be associated with a security zone in a number of ways:
   The port can be directly associated with the logical security zone
   The port can be directly configured with a default 802.1Q VLAN ID. Packets that do not contain a VLAN tag are associated with the default VLAN. Each security zone is configured with a single unique VLAN ID. The security zone that has the same VLAN ID as the port is chosen as the source security zone. A port can be configured to discard untagged packets. Ports cannot be configured with a VLAN ID that is not associated with a security zone.
   Packets that do contain a 802.1Q VLAN tag are associated with the corresponding VLAN ID contained in the tag. The packet is associated with the logical source zone which is configured with the same VLAN ID. If no such zone exists, the packet is dropped. A port may be configured with a set of VLAN ID's to accept—packets containing other VLAN IDs are dropped.
For packets received from the local network stack, these are associated with a security zone in the following way:

A logical security zone called “This Device” is associated with the packets as their source security zone.
A tunnel packet received from step 114 (—see below) and which has been subject to recursive packet processing can be associated at each recursive step with a logical zone. This allows policing of packets within multiple levels of tunnel encapsulation according to policy—each layer of tunnel encapsulation is policed individually.
For packets received from step 116 and which are to be reencapsulated and sent over a tunnel, these can be re-associated with a source security zone in a number of ways:
   A packet encapsulated or decapsulated according to the configuration of a particular IPSec tunnel, is associated with the security zone configured with the IPSec tunnel.
   A packet associated with a GRE tunnel is associated with the security zone configured with the GRE interface
   A packet associated with a remote PPTP or L2TP client, is associated with the security zone configured with the L2TP or PPTP server, as appropriate.
   A packet associated with a local PPTP or PPTP client connection, is associated with the security zone that has been configured with the external virtual interface.
The packet classification record is configured with the security zone as the packet's source zone

Step 106 Does Packet match any session? If yes go to step 107, if no, go to step 108.
A session table is stored internally to track packets flows that correspond to sessions through the device i.e. if the packet is from a source security zone which has already been determined as acceptable and is currently listed in the session table, then it is determined as acceptable without any need to calculate a forwarding path and determining if the policy allows the packet.
The packet is examined and classified by its protocol, its source and destination IP addresses and application. The packet classification record is filled in from this data and compared against a list of session records to determine whether there exists an (acceptable) session corresponding to this packet. The first packet for a session will not find a session entry. A session entry is deleted if the firewall module can determine that the packet corresponds to the end of a session or if the session times out.

Step 107 Perform Packet Inspection and Modification
Certain applications require the session data transmitted within the packets to be inspected to determine whether secondary sessions will be established. The session table is updated with this information.
Packets may need to be modified to support functions such as network address translation. Go to step 113.

Step 108 Calculate Forwarding Path
For packets that do not match any existing session in the session table, the forwarding path is determined. The following is used to determine the forwarding path:
   If the destination IP address of the packet is associated with any IPSec, L2TP or PPTP tunnel, the appropriate tunnel is determined as the forwarding path for the packet. The packet should be tunnelled under the following cases:
      The destination IP address is contained within a destination IP subnet associated with an IPSec tunnel mode connection.
      The destination IP address is the IP address provided to a remote L2TP or PPTP client.
   Otherwise, the next hop is calculated by looking up the forwarding table. The forwarding table provides the IP address where the packet should be forwarded—the next hop IP address.
      If the next hop IP address is a GRE tunnel interface, then the forwarding path is set to the appropriate GRE tunnel
      If the next hop IP address is the L2TP/PPTP client interface, then the forwarding path is set to the appropriate L2TP/PPTP tunnel
      If the next hop IP address is contained within one of the IP subnets associated with an Internal or External local IP Interface, the forwarding path is set to this next hop IP address
   The forwarding path (tunnel or next hop IP address) is added to the packet classification record. Go to Step 109

Step 109. Associate Packet with Logical Destination Zone
If the forwarding path for the packet is determined to be a tunnel, the logical destination zone is the security zone that was configured with the particular tunnel type. A security zone is associated with IPSec, GRE, PPTP and L2TP tunnels.
Otherwise, the destination zone is the security zone where the next hop IP address resides. IP addresses can be associated manually with a security zone or can be learned automatically from the network. If the next hop IP address is identical to one of the device's local IP addresses, the destination security zone is set to the “This Device” security zone.
The destination zone associated with the packet is entered into the packet classification record. Go to Step 110

Step 110. Does Policy Allow Packet? If no, go to step 111, if yes, go to step 112.
A manually entered ordered list of policy rules is scanned and matched against the packet classification record.
At this point the classification record contains the following information:
   Source security zone
   Destination security zone
   Source IP address
   Destination IP address
   Application
If the source and destination security zones are the same, then the policy rules are bypassed.
A policy rule can allow or deny the packet based on matching any one or more of the above attributes. A policy rule can be configured as follows:
   Source security zone—a security zone associated with a VLAN, one or more physical ports, a GRE interface, an IPSec interface, the PPTP or L2TP server configuration, or “This Device”. “ANY” can be configured to match any source security zone.
   Destination security zone—a security zone associated with a VLAN, one or more physical ports, a GRE interface, an IPSec interface, the PPTP or L2TP server configuration, or “This Device”. “ANY” can be configured to match any destination security zone.
   Source IP address—a list of ranges or IP subnets can be configured to match against the source IP address.
   Destination IP address—a list of ranges or IP subnets can be configured to match against the destination IP address
   Application—any of the preconfigured or custom added services can be configured to match against the application associated with the packet.

Step 111. Discard Packet and go to Step 120
If a policy rules denies the packet, the packet and the packet classification record are discarded.

Step 112. Create Session Entry
If a policy rules allows the packet, the classification record is added to the session table to match subsequent packets within the session.

Step 113. Is the packet a local tunnel packet? If yes, go to step 114, if no go to step 115.
A GRE, IPSec, PPTP, L2TP or other tunnelling protocol packet is decapsulated. If the packet classification record indicates that the packet is associated with a tunnelling protocol and is destined to one of the device's local IP addresses, the packet is a tunnel packet.

Step 114. Decapsulate packet
The outer encapsulation associated with the packet is removed and discarded.
The classification record associated with the packet is reset. Go to step 105.
The decapsulated packet is examined, as before, in Steps 105-113 to determine if the packet is allowed.

Step 115. Should packet be tunnelled? If yes, go to step 116, if no, go to step 117.
This is determined by the forwarding path of the packet classification record.

Step 116. Encapsulate packet and go to Step 105
If the destination IP address is contained within a destination IP subnet associated with an IPSec tunnel mode connection, IPSec tunnel mode encapsulation is applied to the packet.
If the destination IP address is the IP address provided to a remote L2TP or PPTP client, the appropriate PPTP or L2TP encapsulation is applied to the packet.
If the next hop IP address is the GRE virtual interface, GRE and optionally IPSec transport mode encapsulation is applied to the packet. (The latter secures the GRE connection.)
If the next hop IP address is the L2TP/PPTP client interface, the appropriate PPTP or L2TP encapsulation is applied to the packet.

Step 117. Is the packet to be VLAN tagged? If “yes” go to Step 118, if “no” go to Step 119.

Step 118 Insert VLAN tag and go to Step 119.

Step 119 Transmit Packet on Network Interface and go to Step 120
The next hop IP address associated with packet is used to determine where to send the packet. A packet can be sent by the firewall module to either or both of the following destinations:
   One or more of the local physical Ethernet ports. The packet is sent to an Ethernet port if it is a broadcast or multicast packet or if the destination IP address has been determined (or configured) to exist on that specific Ethernet port.
   The local TCP/IP stack. The packet is sent to the local TCP/IP stack if it is a broadcast or multicast packet or if the destination IP address corresponds to a local IP address assigned to the device.

Step 120 End Packet Processing.

The Network Traffic Controller

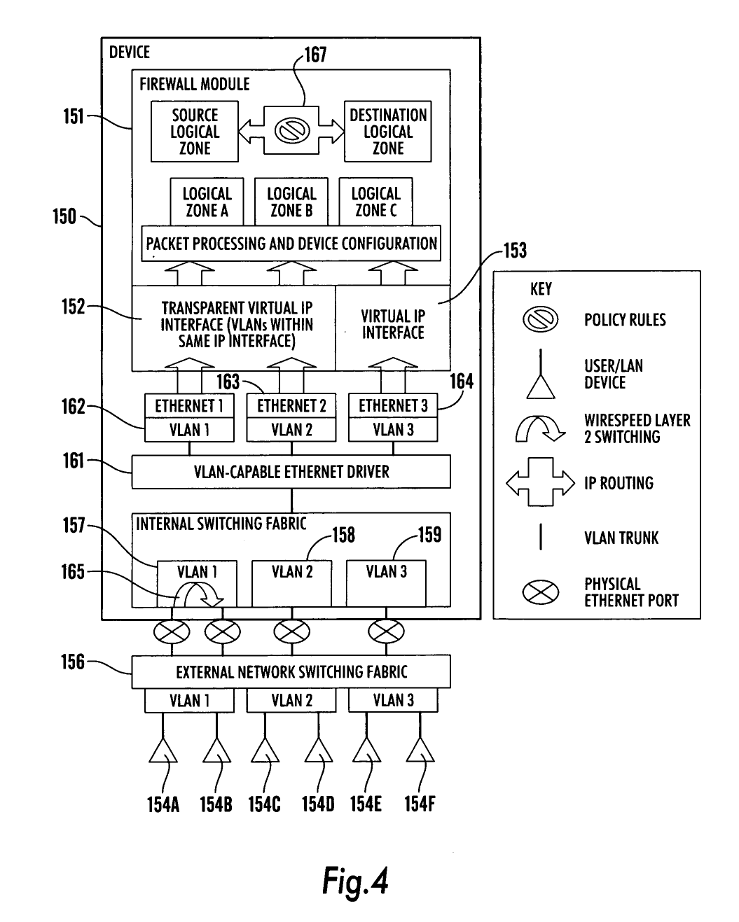

A network traffic controller in accordance with a preferred embodiment of the invention will now be described by reference to FIG. 4. A network traffic controller 150 includes a firewall module 151 which in turn includes a virtual interface 152 and virtual interface 153.

User/LAN devices 154A-154H are connected via connected via network switching fabric 156 to relevant ports 157-159 of the controller 150. Policy rules 165 control the interconnection of devices 154A-H within VLAN1. The ports 157-159 connect via switching fabric to an Ethernet driver 161 which connects the various VLAN to the relevant Ethernet ports 162-164 of the firewall module 151. Policy rules 166 control the layer 2 interconnection of the Ethernet ports 162 and 163 and policy rules 167 control the interconnection of virtual interfaces 152 and 153 and hence control the interconnection in the IP layer of Ethernet port—164 with Ethernet ports 162 and 163.

Security Zones

A security zone can be effectively the same as a VLAN, i.e. a segment of the network that is isolated from other network segments. The network traffic controller always uses VLANs internally for security zones but, like switches, the external Ethernet ports can use untagged VLANs.

Ethernet Ports

Any of the Ethernet ports can be associated with a security zone. If VLAN tagging is enabled and an Ethernet port is associated with a security zone, then that port can be tagged, i.e. the packets to and from the tagged port will contain the VLAN ID associated with the security zone. Otherwise the packets are untagged. In this case, the port can be associated with only one security zone.

If an untagged port is currently associated with a security zone and is configured through the GUI to be associated with another security zone, it will automatically be disassociated from the first security zone. (As with most switches, untagged packets to and from a single Ethernet port can only be associated with a single VLAN (i.e. security zone).

Relationship to IP Subnets

Unlike traditional devices, such as routers, the network traffic controller's IP configuration is not directly associated with a physical port.

The network traffic controller will connect to a single external IP subnet and, optionally, multiple internal IP subnets. Security zones can exist within each IP subnet (internal or external). Firewall policy rules are applied between security zones. Physical Ethernet ports can be associated with any number of security zones when using external VLAN tagging but otherwise must be associated with a single security zone. Packets received on a port with a VLAN tag that is not associated with any of the security zones that contain that port is dropped.

Each IP subnet directly connected to the network traffic controller (internal, external and GRE) will have a Virtual Interface containing its configuration, i.e. IP address, mask, routing protocols enabled, etc.

Security zones that share the same Virtual Interface (VLAN 1 and VLAN 2 in FIG. 4) are transparently firewalled (i.e. bridging—via policy 166 in FIG. 4—of IP-only packets with stateful packet inspection filtering). If they do not share the same Virtual Interface (VLAN 3 does not share the same virtual interface with either VLAN 1 or VLAN 2 in FIG. 4) the security zones are routed firewalled (i.e. IP routing—via policy 167 in FIG. 4—with stateful packet inspection filtering). Both types of firewalling are application-aware and only open dynamic ports when necessary.

Virtual Interfaces (152, 153)

A Virtual Interface provides an IP interface for the Firewall to allow it to connect to one of the external IP subnets. All IP interfaces are “virtual”; they are associated with physical IP interfaces by the configuration of security zones and physical switch ports.

Physical Ethernet ports are associated with Security zones. Security zones are associated with Virtual Interfaces. A Virtual Interface that has no security zone associated with it is effectively inactive. A security zone must be associated with either the external or exactly one of the internal security zones in order to be effective. Only disassociated security zones can be associated with the external or internal Virtual Interfaces.

There are 3 types of Virtual Interfaces:
External Virtual Interfaces that can use a range of mechanism for automatically retrieving an IP address or can use a static IP address. This contains:
   1. Internet access configuration
   2. Dynamic Routing configuration (RIP, multicast).
   3. Zones associated with Virtual Interface
Internal Virtual Interfaces that can only be given a static IP address. They contain:
   1. IP Address/subnet
   2. DNS Configuration
   3. Dynamic Routing configuration (RIP, multicast)
   4. NAT enabled/disabled
   5. External NAT IP Address (optional)
   6. Zones associated with Virtual Interface
GRE Virtual Interfaces, tunnelling between sites, which can only be given a static IP address.
   1. IPSec tunnel used to protect the GRE tunnel
   2. Local IP Address
   3. Peer IP Address
   4. Dynamic Routing configuration (RIP, multicast).
   5. Zone associated with GRE tunnel. Any security zone can be associated with a GRE Virtual Interface, even if it is already associated with another Virtual Interface. This zone is used for policy rules to control the traffic across the GRE tunnel.

An external Virtual Interface is able to be statically configured with or receive its IP configuration from a remote device.

An internal Virtual Interface is able to provide IP configuration via DHCP.

It will be noted from FIG. 4 that:
Ethernet port 1 162 is configured into security zone “LAN” (VLAN ID 1).
Ethernet port 2 163 is also configured into security zone “LAN”; layer 2 switching occurs between ports 1 and 2 with no Firewall policy. This switching is completely performed within the switch subsystem and hence is at wire-speed.
Ethernet port 3 164 is configured into security zone “DMZ” (VLAN ID 2). This zone is configured within internal Virtual Interface 2, which is also used by security zone “LAN”. As it is sharing the same Virtual Interface, traffic between either ports 1 or 2 to/from port 3 is layer 2 switched with policy control. Zones “LAN” and “DMZ” are isolated by VLANs and the switching subsystem forwards all traffic up to the Firewall module, which performs the layer 2 switching in software.

Ethernet port 4 (not shown) is configured into security zone “WAN” (VLAN ID 3). This fixed zone is associated with its default fixed external Virtual Interface 1. As this is using a separate IP configuration to the other security zones, IP routing with firewall policy occurs between IP interfaces “WAN” and “LAN”. Thus the network traffic controller has very flexible security zones. IP traffic within a security zone is switched at wire speed by the switch subsystem. Traffic that crosses a security zone is firewalled and shaped according to the policy defined between the relevant zones.

The network traffic controller offers flexible physical Ethernet interface configurations, in that they can be associated with an existing security zone or a new security zone associated with either an internal or the external Virtual Interface.

Flexible ports are disabled (in switch configuration) in manufacturing.

A flexible port can be configured as a new security zone, or join an existing security zone. If joining an existing security zone, the port becomes switched with the other ports in that same zone by the switch subsystem. If a new security zone, the port becomes firewalled/routed according to the policy rules configured between zones.

Types of Security Zones (Software Architecture)

The network traffic controller uses two types of security zone internally.
Internal security zones are security zones associated with internal Virtual Interfaces.
External security zones are security zones associated with external Virtual Interfaces.

Internal security zones have the following functionality. (External security zones do not support these features):
The network traffic controller DHCP Server can support DHCP clients within the security zone.

External security zones have the following functionality. (Internal security zones do not support these features):
The network traffic controller IPSec, PPTP and L2TP/IPSec Server can use this security zone to establish or terminate tunnels. (Internal zones can only passthrough this traffic.) The security zone needs to be associated with the physical ports that connect to network that these tunnels are established over, e.g. the WAN zone needs to be associated with the WAN physical port, assuming this connects to the Internet access device.

When NAT is configured on an internal Virtual Interface, all security zones within the Virtual Interface use NAT. NAT is applied between these internal security zones and any external security zones. NAT is never applied between internal security zones—traffic is always routed (or bridged if the security zones belong to the same Virtual Interface).

A central component of the network traffic controller is controlling the flow of traffic between the physical Ethernet ports on the network traffic controller. Ethernet ports within the same security zone are in the same VLAN and are switched at wire-speed. The traffic between Ethernet ports that are within separate security zones is “policed” by the network traffic controller. The network traffic controller can use VLAN tagging so that traffic on the same physical Ethernet port but using different VLAN tags, is also policed.

Policy Rules

The network traffic controller polices packet traffic between the security zones according to a manually configured set of policy rules.

After the initial packet in a session matches a policy rule and creates a firewall session, subsequent packets that match the session will not be rescanned against the policy rules. For applications that create secondary sessions, the Firewall secondary sessions are created when parsing the control channel session.

Policy Classification

Policy rules will consist of the following classification components:

| Component | Description |
|---|---|
| Service | One of the active applications defined on |
| | the network traffic controller will have |
| | a predefined list of applications and will |
| | support simple custom applications. A |
| | service group can also be specified. |
| Source security zone | The name of the source security zone, |
| | “This Device” or “ANY” on which |
| | the packet arrived. |
| Destination security zone | The name of the destination security zone |
| | “This Device” or “ANY”. The device |
| | configuration will determine the destination |
| | security zone for a packet. |
| Source IP | All IP addresses, the name of an address |
| | range that is associated with a (list of) |
| | IP address ranges, a single IP subnet, |
| | IP single range or “ANY”. |
| Destination IP | All IP addresses, the name of an address |
| | range that is associated with a (list of) |
| | IP address ranges, a single IP subnet, |
| | IP single range or “ANY”. |
| Schedule | The name of a schedule or “ALWAYS”, |
| | the schedule consists of a (list of) days |
| | and times that this policy rule should |
| | be invoked. If a packet is being processed |
| | outside the schedule associated with a |
| | particular policy rule, that policy rule |
| | is ignored |
| User Authentication | Enabled or disabled. Whether user |
| | authentication is required for this |
| | policy or not |
| Privilege Group | When user authentication is enabled, this |
| | is the name of a Privilege Group with which |
| | a user must be associated for matching |
| | this policy rule. The Privilege Group is a |
| | component of the local user database entries |
| | or is retrieved from RADIUS |

“This Device” Security Zone

As part of policy only, the source or destination security zone can be configured as “This Device”. The “This Device” security zone is for any traffic that is destined for or sent from one of the network traffic controller's Virtual Interface IP addresses.

This can be used to control traffic to or from the network traffic controller itself, e.g. to limit or block HTTP management, SNMP management, ping or any other service supported by the network traffic controller.

Note that if “ANY” is selected for the source or destination security zone in a policy rule, this includes the “This Device” security zone.

Policy Components

Policy rules will consist of the following policy components

| Component | Description |
|---|---|
| Action | Allow, Deny or Content Filter. |
| Inactivity timeout | Timeout in minutes. Firewall sessions are |
| | deleted after this period of inactivity |
| Logging | Enabled or disabled. If enabled for debugging, |
| | a session that matches this policy rule is |
| | logged within the traffic log. |
| Enabled bandwidth | Enabled or disabled. If enabled, the |
| management | parameters below are used. |
| Guaranteed bandwidth | 0 to 99999 kbps. The network traffic |
| | controller will ensure that a session that |
| | matches this policy rule will be provided |
| | with this level of bandwidth. (In effect, |
| | The network traffic controller will throttle |
| | other non-prioritised traffic to ensure |
| | this.) This is mainly to provide pre- |
| | allocated bandwidth for particular |
| | incoming traffic. |
| Per Session/Per Rule | If per session, the guaranteed bandwidth |
| | is provided to every session that matches |
| | this rule; otherwise it is shared between |
| | them. |
| Maximum bandwidth | If a session attempts to use more than |
| | its maximum bandwidth, the excess use is |
| | truncated egress |
| Bandwidth priority | Packets associated with sessions with a |
| | priority higher than other sessions are |
| | transmitted out of their destination |
| | interface before other sessions. This |
| | provides a simple mechanism for outgoing |
| | packet prioritisation. Low latency traffic |
| | must use priority 0. |

Policy rules will affect all packet flow through the network traffic controller. Policy rules can be used to restrict VPN tunnelled traffic or provide bandwidth management over VPNs for specific applications by associating the VPN tunnel with one zone, e.g. VPN and applying a policy rule between this zone and, say, the LAN zone.

We have thus described an arrangement in which:

1) Network policies are specified using logical security zones that are independent of type of network entities being policed—ports, VLANs, tunnels.

2) A single network policy rule can apply to multiple types of network entity. A logical security zone can include a combination of one or more of each type of network entity.

3) Migration from one type of network infrastructure to another (e.g. IPSec tunnelling to GRE tunneling) does not require changes to network policy.

4) New types of network entities (e.g. even new tunnelling protocols) can be introduced without changing policy model.

5) Network policy can apply to each layer within a layered tunnel model. This can be supported by a single device.

6) Any type of action supported by network policy, such as allow, deny, traffic shaping, filtering, logging or redirecting is configured the same way independent of network entity that it is being applied to.

The invention is not restricted to the details of the foregoing examples.

What is claimed is:

1. A method for controlling traffic between different entities on a network in accordance with a predetermined policy in which the network policy is applied to each layer within a layered tunnel model.

2. A method for controlling traffic between different entities on a network in which packets of received data are inspected, and if encapsulated, are decapsulated layer by layer and, after each layer is decapsulated, the packet is inspected to determine if the packet is to be acted upon or discarded.

3. Apparatus for controlling traffic between different entities on a network in which packets of received data are inspected, and if encapsulated, are decapsulated layer by layer and, after each layer is decapsulated, the packet is inspected to determine if the packet is to be acted upon or discarded.

4. Apparatus as claimed in claim 3 comprising;
(a) means to receive packets of data,
(b) means to inspect each packet and discard the packet if it is determined that it should not be acted upon,
(c) means to determine if the packet is encapsulated,
(d) means to decapsulate the inspected packet if it is encapsulated,
(e) means to repeat steps (b), (c) and (d) on the decapsulated packet, and
(f) means to act upon the packet

5. Apparatus as claimed in claim 3 in which if the packet is to be acted upon it is forwarded or logged or filtered or shaped.

6. A method as claimed in claim 2 comprising:
(a) receiving packets of data,
(b) inspecting each packet and discarding the packet if it is determined that it should not be acted upon,
(c) determining if the packet is encapsulated,
(d) decapsulating the inspected packet if it is encapsulated,
(d) repeating steps (b), (c) and (d) on the decapsulated packet, and
(e) acting upon the packet.

7. The method of claim 6 in which if the packet is to be acted upon it is forwarded or logged or filtered or shaped.

8. The method of claim 6 in which the packet is encapsulated before forwarding.

9. The method of claim 6 in which the step (b) includes inspecting the packet to see if it matches a previous session and if so passing to step (c), and if not,
(b1) calculating a forwarding path for the packet
(b2) associating the packet with a logical forwarding zone,
(b3) determining if the policy allows the packet to be acted upon,
(b4) if the policy does not allow the packet to be acted upon, discarding the packet,
(b5) if the policy does allow the packet to be acted upon, creating a new session entry and proceeding to step (c).

10. A computer program on a computer readable medium for controlling traffic between different entities on a network in which packets of received data are inspected, and if encapsulated, are decapsulated layer by layer and, after each layer is decapsulated, the packet is inspected to determine if the packet is to be acted upon or discarded, said program comprising
(a) program means for receiving packets of data,
(b) program means for inspecting each packet and discarding the packet if it is determined that it should not be acted upon,
(c) program means for determining if the packet is encapsulated,
(d) program means for decapsulating the inspected packet if it is encapsulated,
(e) program means to repeat steps (b), (c) and (d) on the decapsulated packet, and
(f) program means to act upon the packet.

11. A method for controlling traffic between different entities on a network in accordance with a predetermined policy, the policy being applied to network traffic being passed between logical zones, wherein each logical zone can be simultaneously associated with one or more types of network entity

12. The method of claim 11 in which there is provided
(a) defining a plurality of zones,
(b) defining a plurality of actions or policies,
(c) receiving packets of data,
(d) inspecting the packet to determine its source zone and its destination zone
(e) applying the policy relating to the relevant source and destination zones to determine from that policy whether the packet should be acted upon or discarded, characterised in that at least one of said source and destination zones includes both physical entities and logical entities.

13. The method of claim 12 in which if the packet is to be acted upon it is forwarded or logged or filtered or shaped.

14. The method of claim 12 in which said at least one of said zones includes entities relating to the time of receipt of the packet, or the application (e.g.TCP/UDP IP services such as HTTP, SMTP), number of bytes in the packet, a group of network locations, including physical ports, VLANs, or logical tunnel termination points for IPSec, GRE, PPTP or L2TP.

15. The method of claim 13 in which the network policy is classified in terms of source and destination logical zone

16. Apparatus for controlling traffic between different entities on a network in, accordance with a predetermined policy, the policy being applied to network traffic being passed between logical zones, wherein each logical zone can be simultaneously associated with one or more types of network entity

17. The apparatus of claim 16 in which there is provided
(a) a database defining a plurality of zones,
(b) a database defining a plurality of actions or policies,
(c) means to receive packets of data,
(d) means to inspect the packet to determine its source zone and its destination zone
(e) means to retrieve the policy relating to the relevant source and destination zones from the database and to determine from that policy whether the packet should be acted upon or discarded,
characterised in that at least one of said source and destination zones includes both physical entities and logical entities,

18. The apparatus of claim 17 in which said at least one of said zones includes entities relating to the time of receipt of the packet, or the application (e.g. TCP/UDP IP services such as HTTP, SMTP), number of bytes in the packet, a group of network locations, including physical ports, VLANs, or logical tunnel termination points for IPSec, GRE, PPTP or L2TP.

19. The apparatus of claim 18 in which the network policy is classified in terms of source and destination logical zone

20. A computer program on a computer readable medium loadable into a digital computer, said computer program comprising software for performing the steps of claim 12.
